(19) United States
(12) Patent Application Publication
(10) Pub. No.: US 2010/0018174 A1
(43) Pub. Date: Jan. 28, 2010

(54) AIR CLEANER

(75) Inventors: Norio KOMATSU, Nagano (JP); Yasumasa Nojiri, Nagano (JP); Satoshi Kubota, Nagano (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: NIPPON ROKAKI CO., LTD., Tokyo (JP)

(21) Appl. No.: 12/178,007

(22) Filed: Jul. 23, 2008

(51) Int. Cl. B01D 29/58

(52) U.S. Cl. 55/480

(57) ABSTRACT

In a filter element, at both ends of a cylindrical main filter medium having a space formed on its inner periphery side there are respectively formed a first cap having a communication port for communication of the space with the exterior and a second cap for closing the space, and a pre-filter medium is inserted removably into the space from the communication port. A case comprises a body case for accommodating the filter element removably from an opening thereof in a state in which a gap is formed between the body case and the outer periphery of the main filter medium, and a lid for closing the opening. With the lid attached to the body case, a gas inflow space (flow path) with the communication port positioned therein and a gas outflow space (flow path) with the gap positioned therein are partitioned from each other by a partitioning portion (upper fitting portion). An inlet port provides communication between the gas inflow space and the exterior and an outlet port provides communication between the gas outflow space and the exterior.

### BACKGROUND OF THE INVENTION

1. Field of the Invention

The present invention relates to an air cleaner for filtration of gas.

2. Discussion of the Background

In conventional air cleaners used for example in engines mounted on automobiles, construction machines, or the like, a cylindrical type filter medium is widely adopted in order to increase the filtration capacity while attaining the reduction in size of the devices. In connection with such air cleaners it is known that the filtration performance is improved by using a pre-cleaner. More particularly, an air cleaner as a combination of a pre-cleaner and a cylindrical type filter medium has heretofore been proposed. For example, an air cleaner for a general-purpose engine, which air cleaner is a unitized cleaner of a pre-cleaner and a cylindrical type filter medium, is disclosed in Japanese Unexamined Patent Publication No. 2005-201193.

The air cleaner as a combination of a pre-cleaner and a cylindrical type filter medium inevitably becomes larger in size due to its structure. Even in the case of the air cleaner having such a unitized structure of a pre-cleaner and a cylindrical type filter medium as described in Patent Literature 1, it is impossible to solve the problem that the whole of the air cleaner becomes larger in size.

Moreover, in the air cleaner using a cylindrical type filter medium, gas to be filtered is introduced from the outer to the inner periphery side of the filter medium. This structure permits captured dust or the like to adhere to the outer periphery side of the filter medium. There is a fear that the dust or the like thus adhered to the outer periphery side of the filter medium may come off from the filter medium and drop to the interior of an air cleaner case when a filter element is removed for replacement or for any other purpose. Such dropping of dust or the like into the air cleaner case causes a danger of the dust or the like getting into an engine or any other part from a gas outlet port. To prevent the occurrence of such a danger it is necessary to take an appropriate countermeasure such as, for example, installing an inner filter element in the gas outlet port. However, taking such a countermeasure results in structural complication.

### SUMMARY OF THE INVENTION

It is an object of the present invention to reduce the size of an entire air cleaner while allowing the air cleaner to have a pre-cleaner function.

It is another object of the present invention to prevent the entry of dust or the like into an outlet port of a case with use of a simple structure different from the conventional structure when removing a filter element from the case.

The air cleaner of the present invention includes a filter element for filtration of gas, and a case for accommodating the filter element. The filter element includes a cylindrical main filter medium having a space formed on its inner periphery side, a first closure member provided at one end portion of the main filter medium and having a communication port communicating the space with the exterior, a second closure member provided at an opposite end portion of the main filter medium to close the space, and a pre-filter medium accommodated within the space. The case includes a body case having an opening which permits the filter element to be inserted therein with the second closure member in the read and accommodating the filter element removably in a state in which a gap is formed between the body case and the outer periphery of the main filter medium, a lid attached to the body case removably to open and close the opening, a partitioning portion for dividing the a gas inflow space with the communication port positioned therein from a gas outflow space with the gap positioned therein while maintaining airtightness and in a state in which the lid is attached to the body case; a gas inlet port communicating the gas inflow space with the exterior and a gas outlet port communicating the gas outflow space with the exterior.

### BRIEF DESCRIPTION OF THE DRAWINGS

FIG. 1 is a front view in vertical section showing an air cleaner according to an embodiment of the present invention.

FIG. 2 is a front view in vertical section of the air cleaner, showing a state in which a lid is open and a filter element is being taken out from a body case.

FIG. 3A is a perspective view of a first cap (first closure member) as seen from below.

FIG. 3B is a perspective view of a second cap (second closure member) as seen from above.

FIG. 4 is a horizontal sectional view showing the filter element.

FIG. 5 is a perspective view of a part of a main filter medium as seen from the inner periphery side thereof, showing another example of restrictive portions.

FIG. 6 is a perspective view showing a pre-filter medium.

FIG. 7 is a horizontal sectional view showing another example of a main filter medium.

FIG. 8 is a horizontal sectional view of a filter element, showing another example of a pre-filter medium.

FIG. 9 is a horizontal sectional view of a filter element, showing a still another example of a pre-filter medium.

FIG. 10 is a side view in vertical section showing another example of a first cap.

FIG. 11 is a side view in vertical section showing a still another example of a first cap.

FIG. 12 is a graph showing a relation between air flow resistance and flow rate in the air cleaner.

FIG. 13 is a graph showing a relation between dust holding capacity and air flow resistance in the air cleaner.

### DETAILED DESCRIPTION OF THE INVENTION

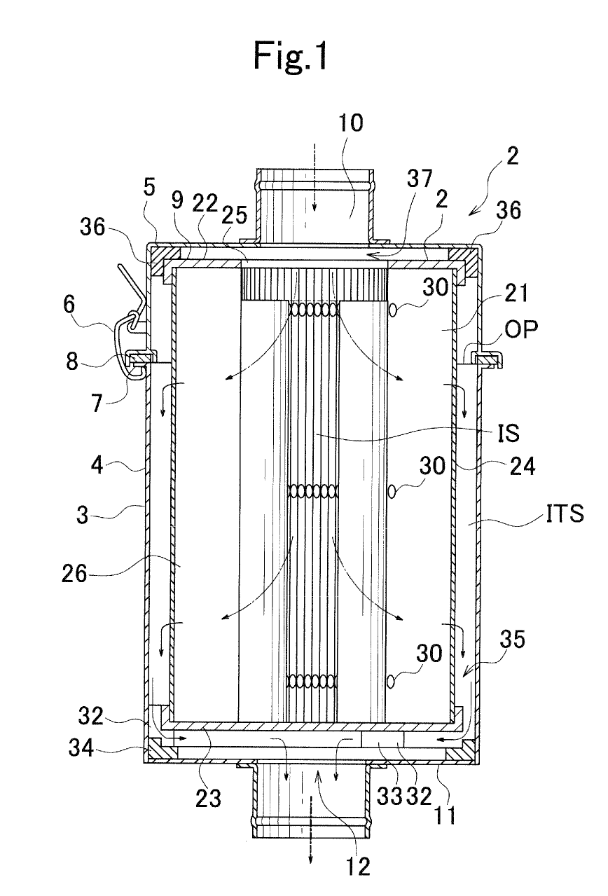

An embodiment of the present invention will be described hereinunder with reference to FIGS. 1 to 13.

FIG. 1 is a front view in vertical section showing an air cleaner embodying the present invention. The air cleaner, indicated at 1, is comprised of a filer element 2 for filtration of gas and a case 3 which accommodates the filter element 2.

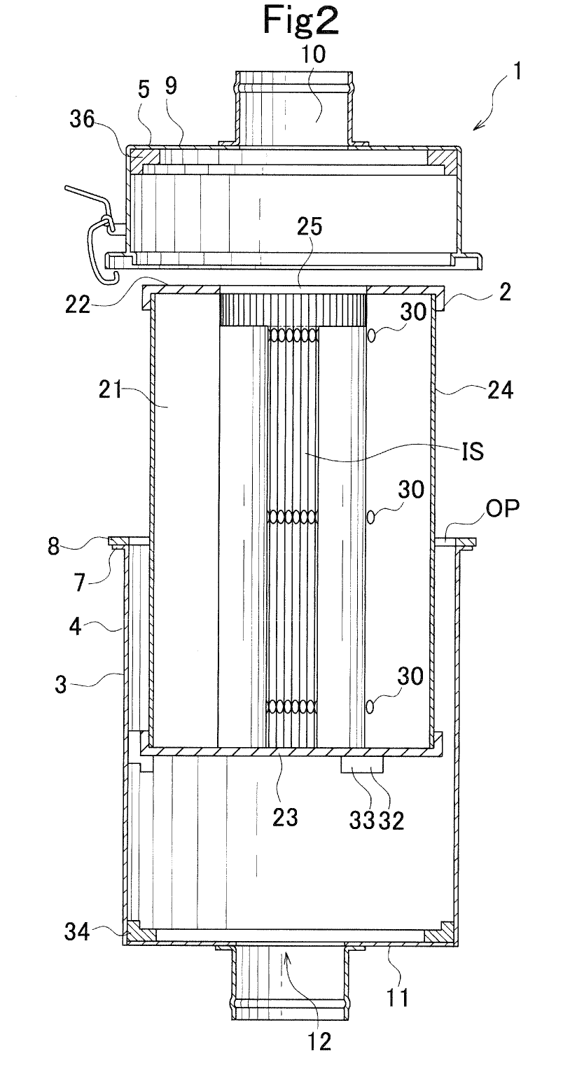

The case 3 includes a body case 4 having an opening OP to make the body case open on its upper side and a lid 5 attached to the body case 4 removably to open and close the opening OP. Plural hooks 6 (only one is shown in FIGS. 1 and 2) as a fixing mechanism for fixing the lid 5 to the body case 4 are provided at lower positions of the outer periphery of the lid 5. The lid 5 is fixed to the body case 4 by bringing the hooks 6 into engagement with retaining portions 7 formed at upper positions of the body case 4. A packing 8 is fixed to the opening OP of the body case 4 so as to be sandwiched between the body case 4 and the lid 5, thereby ensuring airtightness between the body case 4 and the lid 5.

In an upper wall 9 of the lid 5 is formed an inlet port 10 for allowing gas such as, for example, air as an object to be filter to flow into the interior of the case 3. In a bottom wall 11 of the body case 4 is formed an outlet port 12 for allowing the gas to flow out from the interior of the case 3. The inlet port 10, outlet port 12 and filer element 2 are arranged coaxially.

FIG. 2 is a front view in vertical section of the air cleaner, showing a state in which the lid is open and the filter element is being taken out from the body case. As shown in the same figure, the lid 5 is opened by disengagement of the hooks 6 from the retaining portions 7. With the lid 5 thus opened, the filter element 2 can be inserted into and removed from the body case 4.

The fixing mechanism for fixing the lid 5 to the body case 4 is not limited to the use of hooks 6, but there may be used, for example, screws (not shown).

A description will now be given about the filter element 2. The filter element 2 is in the shape of a hollow cylinder wherein a pair of upper first cap 22 and lower second cap 23 as first and second closure members, respectively, are fixed to both axial ends of a cylindrical main filter medium 21. Thus, a space IS is formed on the inner periphery side of the main filter medium 21. Plural (seven in this embodiment) pre-filter media 101 are accommodated within the space IS thus formed on the inner periphery side of the main filter medium 21 (as to the pre-filter media 101 a description will be given later).

A cylindrical, metallic mesh member 24, which covers the outer periphery of the main filter medium 21, is arranged between the first and second caps 22, 23. The metallic mesh member 24 covers the outside of the main filter medium 21 to prevent the main filter medium 21 from being deformed to the outer periphery side. The metallic mesh member 24 has plural pores (not shown), which are larger in diameter than the pores of the main filter medium 21.

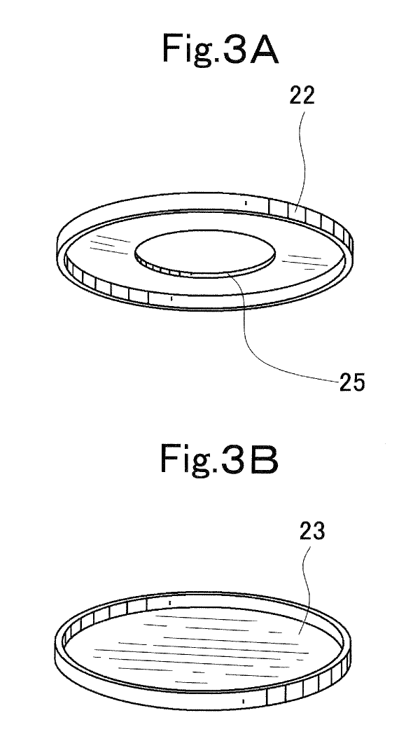

FIG. 3A is a perspective view of the first cap 22 as seen from below. As shown in the same figure, the first cap 22 is formed in the shape of a disc. In a center part of the first cap 22, a communication port 25 for communication between the interior and exterior of the filter element 2 is formed.

FIG. 3B is a perspective view of the second cap 23 as seen from above. As shown in the same figure, the second cap 23 is formed in a disc shape like the first cap 23. On the other hand, unlike the first cap 22, the second cap 23 is not formed with any aperture corresponding to the communication port 25.

The first cap 22 and the second cap 23 function to maintain airtightness at both ends of the main filter medium 21 so that gas flows from the communication port 25 to the space IS formed inside the main filter medium 21, then passes through the main filter medium 21 and flows out to the exterior of the filter element 2. In the filter element 2, the interior and exterior of the filter element are put in communication with each other by both communication port 25 and main filter medium 21.

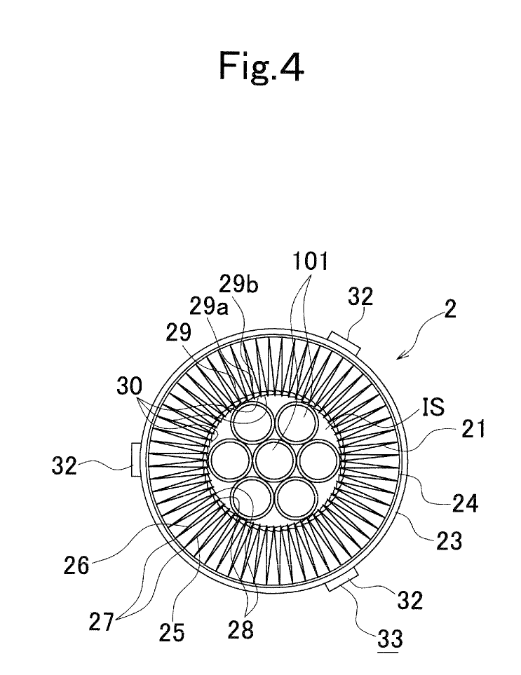

FIG. 4 is a horizontal sectional view showing the filter element 2. The main filter medium 21 is formed in a cylindrical shape as noted above and is circumferentially formed with plural pleats 26. In the main filter medium 21, outer bent portions 27 positioned on the outer periphery side and bent to the inner periphery side, and inner bent portions 28 positioned on the inner periphery side with respect to the outer bent portions 27 and bent to the outer periphery side are formed alternately in the circumferential direction, where by the pleats 26 are formed. Such a main filter medium 21 is formed by bending sheet-like filter medium in a bellows shape so that top-bent portions and bottom-bent portions are positioned alternately and subsequently by joining both ends thereof into a cylindrical shape. Plural pores (not shown) are formed in the main filter medium 21, and with this structure, the main filter medium 21 filters gas. As examples of the material of the main filter medium 21, mention may be made of paper and metal.

In the filter element 2, the diameter of an imaginary circle passing the inner bent portions 28 which form the space IS is set so as not to become smaller than the diameter of the communication port 25 formed in the first cap 22. The imaginary circle passing the inner bent portions 28 is positioned so as not to be protrude inwards from the inner periphery of the communication port 25.

As shown in FIG. 1, the diameter of the filter element 2 is set to a value permitting a gap ITS to be formed between the filter element 2 and the inner periphery surface of the body case 4 in a state in which the filter element is accommodated within the body case 4.

Projections 30 as restrictive portions for restricting decrease of the spacing between adjacent inner bent portions 28 are formed on an inner surface 29 of the main filter medium 21. The projections 30 are formed in a projecting shape from the inner surface 29 to the inside of the pleats 26. More specifically, for each pleat 26, plural projections 30 are formed vertically linearly on one opposed surface 29a among opposed surfaces 29a and 29b confronting each other inside the pleat 26. The projections 30 can be formed, for example, by bonding resinous hot melt to the main filter medium 21.

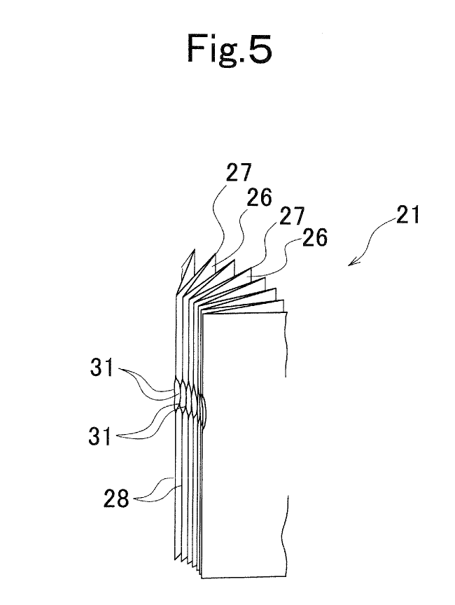

FIG. 5 is a perspective view of a part of a main filter medium 21 as seen from the inner periphery side thereof, showing another example of restrictive portions. As restrictive portions, the inner bent portions 28 of the main filter medium 21 may be partially projected to both sides, i.e., inside the pleats 26, to form projections 31, which may be provided on the inner bent portions 28 respectively. The projections 31 are formed by a method wherein at the time of forming bending streaks on a sheet-like filter medium for forming the inner bent portions 28 of the main filter medium 21, such bending streaks are not formed in the portion where the projections 31 are to be formed, then the main filter medium 21 is bent along the bending streaks to form the inner bent portions 28.

The restrictive portions are not limited to those described above. Any other restrictive portions will do insofar as they restrict narrowing of the spacing between adjacent inner bent portions 28. For example, vertically long reinforcing members may be attached to the inner bent portions 28 to enhance the rigidity of the filter medium, thereby providing restrictive portions.

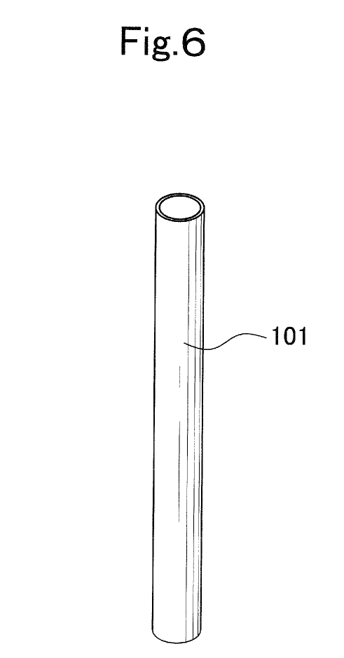

FIG. 6 is a perspective view showing a pre-filter medium 101. As shown in the same figure, the pre-filter medium 101 is formed by a cylindrical member. As an example, such a cylindrical pre-filter medium 101 is formed by maintaining a sheet-like filter medium in a cylindrical shape. In this case, the filter medium has a structure of more coarse pores than in the main filter medium 21 and is formed of resin or metal for example. If suffices for the pre-filter medium 101 to be formed of a filter medium having pores sized to a degree not only satisfying a relative relation with respect to the main filter medium 21 but also permits the exhibition of performance as a pre-cleaner. It is preferable that the coarseness of the pores in the pre-filter medium 101 be set to such a degree as the air flow resistance is not increased markedly by provision of the pre-filter medium 101, more preferably, to such a degree as the air flow resistance undergoes little change regardless of whether the pre-filter medium 101 is present or not.

A description will now be given about a filtration performance range of the main filter medium 21 and that of the pre-filter medium 101. It is preferable for the main filter medium 21 to have a pore size (MEAN) of 35 to 45 μm. Likewise, it is preferable for the pre-filter medium 101 to have an opening area of 3.0 to 10.0 mm².

Though not shown, the cylindrical pre-filter medium 101 is open in its upper portion and is closed in its bottom portion. Therefore, in a state in which the pre-filer medium 101 is accommodated within the space IS formed on the inner periphery side of the main filter medium 21 shown in FIGS. 1 and 2, the upper opening portion of pre-filter medium 101 faces toward the first cap 22, while the closed bottom of the pre-filter medium 101 is positioned on the second cap 23 side.

As shown in FIGS. 1 and 2, the length of the pre-filter medium 101 is set shorter than the axial length of the main filter medium 21. Therefore, the bottom of the pre-filter medium 101 is supported by the second cap 23 and in this state the pre-filter medium 101 is held in a state in which its upper portion does not reach the first cap 22.

The following description is now provided about a mounting structure for mounting the filter element 2 to the case 3.

A description will be given first about a lower-side mounting structure. As shown in FIGS. 1 to 3, plural (three in this embodiment) fitting pieces 32 of a stepped shape are radially positioned and fixed to the outer periphery of the lower, second cap 23 of the filter element 2. Fitting portions 33 on the filter element 2 side are constituted by the fitting pieces 32. On the other hand, in an inner lower portion of the body case 4 there is formed an annular, lower fitting portion 34 of a stepped shape with which the fitting portions 33 of the filter element 2 are fitted inside removably. As noted previously, with the filter element 2 received into the body case 4, the gap ITS is formed between the outer periphery of the filter element 2 and the inner periphery of the body case 4 (see FIG. 1). Therefore, with the fitting portions 33 of the filter element 2 fitted with the lower fitting portion 34, a flow path 35 is formed in the interior of the case 3 to provide communication between the outer periphery side of the main filter medium 21 and the output port 12 of the body case 4.

As an upper-side mounting structure, an annular, upper fitting portion 36 of a stepped shape for fitting therewith of the upper, first cap 22 of the filter element 2 is formed inside the lid 5. In a state in which the lid 5 is attached to the body case 4, the upper, first cap 22 of the filter element 2 is fitted with the upper fitting portion 36. In a state in which the upper, first cap 22 of the filter element 2 is fitted with the upper fitting portion 36, a flow path 37 for communication between the inlet port 10 of the lid 5 and the communication port 25 of the filter element 2 is formed in the interior of the case 3. At this time, the inlet port 10 is in communication with only the communication port 25 of the filter element 2 through the flow path 37 in the interior of the case 3.

With this structure, when the fitting portions 33 of the filter element 2 are fitted with the lower fitting portion 34 of the body case 4, the lid 5 is closed and fixed with the hooks 6 to the body case 4, whereby the upper, first cap 22 of the filter element 2 is fitted with the upper fitting portion 36 of the lid 5 and the filter element 2 is held grippingly by both body case 4 and lid 5 and is fixed to the case 3. This fixed state is released when the lid 5 is opened, thereby permitting removal of the filter element 2 from the case 3.

A further description will now be given about the function of the upper fitting portion 36. The flow path 37 which provides communication between the inlet port 10 of the lid 5 and the communication port 25 of the filter element 2 constitutes a gas inflow space in which the communication port 25 is positioned. The flow path 35 which provides communication between the outer periphery side of the main filter medium 21 and the outlet port 2 of the body case 4 constitutes a gas outflow space in which the gap ITS is positioned. As is apparent from FIG. 1, the upper fitting portion 36 functions to partition the gas inflow space-constituting flow path 37 and the gas outflow-space constituting flow path 35 from each other while maintaining airtightness.

In such a construction, the to-be-filtered gas having entered the interior of the case 3 from the inlet port 10 flows like arrows indicated in FIG. 1. The gas having entered the interior of the case 3 from the inlet port 10 flows along the flow path 37 and enters the interior of the filter element 2 through the communication port 25. The gas having entered the interior of the filter element 2 passes through the flow path 37 serving as a gas inflow space, then a portion of the gas passes through the pre-filter media 101 and then through the main filter medium 21, while the remaining portion of the gas passes directly through the main filter medium 21, further, both portions pass through the metallic mesh member 24 and flow out to the exterior of the filter element 2. Thereafter, the gas flows along the flow path 35 serving as a gas outflow space, reaches the outlet port 12 of the case 3 and flows out to the exterior of the air cleaner 1.

In such a flow of gas to be filtered, dust or the like contained in the gas moves together with the gas and in the course of this movement it is captured by the pre-filter media 101 and the main filter medium 21 and is thereby removed from the gas. More particularly, of the dust or the like contained in the gas to be filtered, 20% to 30% of dust is pre-captured by the pre-filter media 101, not reaching the main filter medium 21. Therefore, it is possible to improve the filtration performance and attain a long service life of the main filter medium 21.

Besides, the pre-filter media 101 are accommodated within the space IS formed by the main filter medium 21. Since such a structure permits the adoption of a flow structure wherein the to-be-filtered gas having entered from the communication port 25 of the filter element 2 moves from the inside to the outside of the main filter medium 21, it is possible to realize both pre-filtration by the pre-filter media 101 and main filtration by the main filter medium 21. Further, the whole of the air cleaner 1 can be reduced in size while ensuring the pre-cleaner function.

Moreover, since the gas to be filtered flows in through the communication port 25 of the filter element 25, then moves from the inside to the outside of the main filter medium 21 and in the course of this movement the gas passes through both pre-filter media 101 and main filter medium 21, the inside of the pre-filter medium 101 and the inside of the pleats 26 of the main filer medium 21 function as dust sumps and the dust or the like captured by both pre-filter media 101 and main filter medium 21 accumulate inside the pre-filter media 101 and the main filter medium 21. It follows that the dust or the like captured by both pre-filter media 101 and main filter medium 21 is present in the interior of the filter element 2 and not present on the outer periphery side of the filter element. Therefore, even if the dust or the like captured by both pre-filter media 101 and main filter medium 21 peels off from both filter media due to vibration when removing the filter element 2 from the case 3 for replacement or washing of the filter element, the dust or the like stays within the filter element 2 and is prevented from falling to the exterior of the filter element. Thus, the dust or the like captured by both pre-filter media 101 and main filter medium 21 is prevented from falling to the interior of the case 3 and is prevented from entering the outlet port 12.

In the conventional air cleaner there is adopted a structure wherein gas is passed through a filter medium from outside to inside of the filter medium in order to increase the filtration capacity of the filter medium and the outside of pleats is allowed to function as a dust sump. On the other hand, in the air cleaner 1 of this embodiment, in order to attain the reduction of cost and simplification of the structure of preventing the entry of dust or the like into the outlet port 12 of the case when removing the filter element 2 from the case 3, as described above, the communication port 25 of the filer element 2 is put in communication with the inlet port 10 of the case 3 and the outer periphery side of the main filter medium 21 is brought into communication with the outlet port 12, thereby preventing the entry of dust or the like into the output port 12 when removing the filter element 2. Therefore, in the air cleaner 1 of this embodiment, without the provision of any special structure, it is possible to prevent the entry of dust or the line into the outlet port 12 when removing the filter element 2. As a result, it is possible to simplify the structure and reduce the manufacturing cost.

In the conventional air cleaner, since gas flows from outside to inside of the filter medium, a metallic core member is provided inside the filter medium for the purpose of preventing an inward deformation of the filter medium due to the flow of gas. On the other hand, in this embodiment, since gas flows from inside to outside of the main filer medium 21, it is not necessary to use such a core member.

In the course of the above filtration there sometimes occurs a case where a force acting to move adjacent bent portions 28 of the main filter medium 21 in mutually close contacting directions is exerted on the main filter medium 21. In this case, if the main filter medium 21 is low in rigidity, for example, if it is made of paper, the main filter medium 21 is apt to be influenced by the force. In this embodiment, however, for example the projections 30 are provided in the main filter medium 21 as restrictive portions for restricting decrease of the spacing between adjacent inner bent portions 28, whereby the spacing in the main filter medium 21 is prevented from becoming narrow. Thus, adjacent inner bent portions 28 in the main filter medium 21 are prevented from coming into completely close contact with each other which would result in closing of the pleats 26. Consequently, a decrease in filtration capacity of the main filter medium 21 resulting from closure of the pleats 26 is prevented.

In this embodiment, since the restrictive portions are the projections 30 or 31 projecting inside the pleats 26 formed in the main filter medium 21, it is possible to make the restrictive portions simple in structure.

In the main filter medium 21 used in this embodiment, since the outer bent portions 27 positioned on the outer periphery side and bent to the inner periphery side and the inner bent portions 28 positioned on the inner periphery side with respect to the outer bent portions 27 and bent to the outer periphery side are provided alternately in the circumferential direction to form the pleats 26, the pleats 26 are realized by a simple structure.

In this embodiment the bottom of each pre-filter medium 101 is closed. That is, the second cap 23 side of the pre-filter medium 101 is closed in a state in which it is accommodated within the space IS formed by the main filter medium 21. Consequently, dust or the like which has come off from the inner surface of each pre-filter medium 101 stays in the interior of the pre-filter medium and does not fall into the space IS formed between the main filer medium 21 and pre-filter medium 101. Therefore, in the filter element 2 of the structure wherein the main filter medium 21 is washed and re-used, dust or the like which has fallen from the inside of each pre-filter medium 101 does not get into the space IS and hence the washing of the main filter medium 21 becomes easier.

In this embodiment, moreover, since the number of the pre-filter media 101 are plural, it is possible to increase the filtration capacity of the pre-filter media 101 and hence possible to improve the pre-filtration efficiency.

Additionally, since in this embodiment each pre-filter medium 101 is formed shorter than the axial length of the main filter medium 21, the space IS between the upper portions of the pre-filter media 101 and the first cap 22 is maintained in the state of a gap, whereby it is possible to decrease the air flow resistance of the gas flowing into the filter element 2 through the communication port 2.

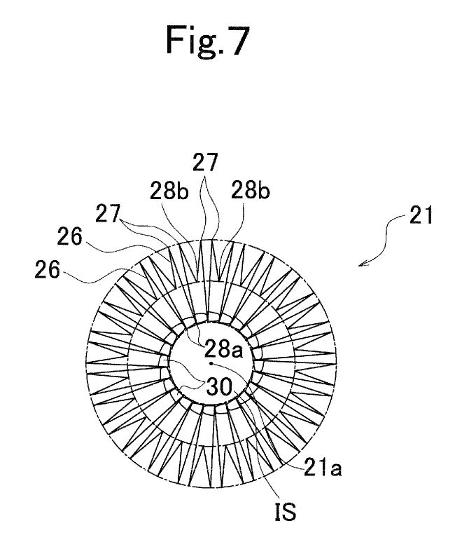

FIG. 7 is a horizontal sectional view showing another example of a main filter medium 21. In the air cleaner 1 there is adopted a structure for the reduction of cost and simplification of the structure of preventing the entry of dust or the line into the outlet port 12 when removing the filter element 2, whereby the inside of the pleats 26 of the main filter medium 21 is allowed to function as dust sumps. As a result, the filtration capacity becomes smaller than in the conventional air cleaner. In view of this point an example of a technique for increasing the filtration capacity of the air cleaner 1 will be described below.

A filter medium shown in FIG. 7 is formed by an M-bent shape. More specifically, as inner bent portions 28 there are two types which are inner bent portions 28a positioned close to an axis 21a of the main filter medium 21 and inner bent portions 28b distant from the central axis 21a. The inner bent portions 28a and 28b are provided alternately in the circumferential direction with outer bent portions 27 therebetween. When viewed from above, the main filer medium 21 has a shape such that plural letters “M” are arranged in the circumferential direction.

According to this construction, on condition that the same filtration area as that of the previous filter medium 21 not M-bent is obtained by the main filter medium of FIG. 7, the spacing between adjacent inner bent portions 28b positioned on the innermost periphery side can be made wider than the spacing between adjacent inner bent portions 28 in the previous main filter medium 21. As a result, the capacity inside the pleats 26, i.e., the dust sump capacity, becomes larger and hence it is possible to increase the filtration capacity.

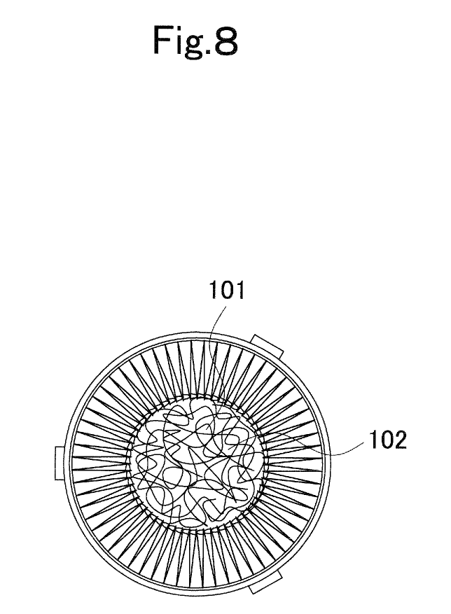

FIG. 8 is a horizontal sectional view of a filer element, showing another example of a pre-filter medium 101. The pre-filter medium 101 introduced in this embodiment is formed by a cylindrical member. On the other hand, as still another example, the pre-filter medium 101 may be formed by a lump of plural fibrous members 102. The fibrous member 102 is formed, for example, by metallic fibers or paper fibers.

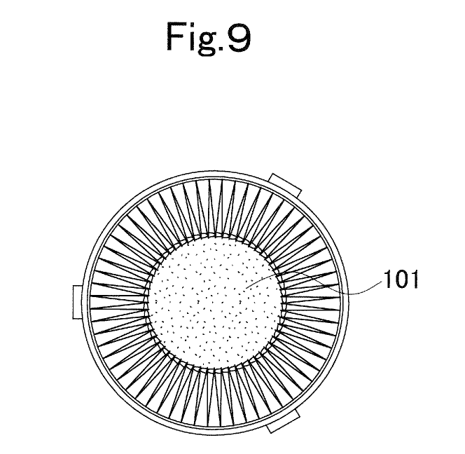

FIG. 9 is a horizontal sectional view of a filter element, showing still another example of a pre-filter medium 101. According to this example the pre-filter medium 101 may be formed by a spongy member.

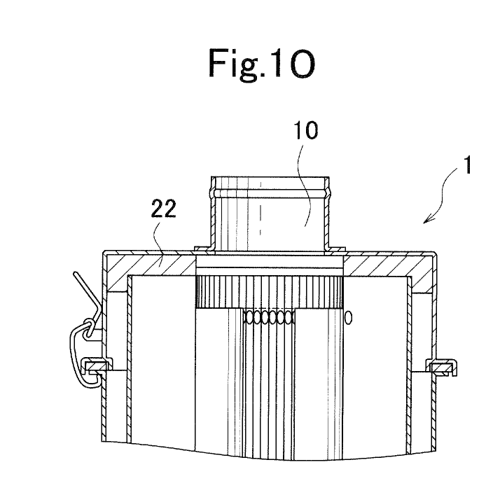

FIG. 10 is a sectional view in vertical section showing another example of a first cap 22. As shown in the same figure, the first cap 22 may be formed integrally with the partitioning portion 36 (see FIG. 1) with use of a member having sealing properties, e.g., urethane rubber.

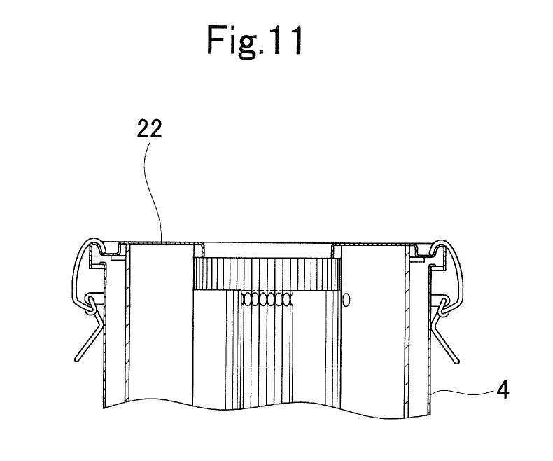

FIG. 11 is a side view in vertical section showing still another example of a first cap 22. As shown in the same figure, the first cap 22 may be formed so as to serve also as the lid 5 (see FIG. 1) and be fixed to the body case 4.

### EXAMPLE

The inventors of the present invention has actually fabricated such an air cleaner 1 as described above in the embodiment and confirmed the effect of the pre-filter medium 101 by experiments. More particularly, we have checked by experiments the relation between air flow resistance and flow rate in the air cleaner 1 and the relation between dust holding capacity and air flow resistance in the air cleaner 1.

The pre-filter medium actually used in the experiments was such a pipe-like one as illustrated in FIG. 6. The pre-filter medium 101 used in the experiments has been formed in the shape of a pipe by spirally winding a band-like member having plural openings of about 1.0 mm×5.0 mm.

The following are filtration performances of the main filter medium 21 and the pre-filter medium 101 both used in the experiments:
Main filer medium 21 [pore size (MEAN)]=43 μm
Pre-filter medium 101 [opening area, opening ratio]−5.0 mm², about 20%

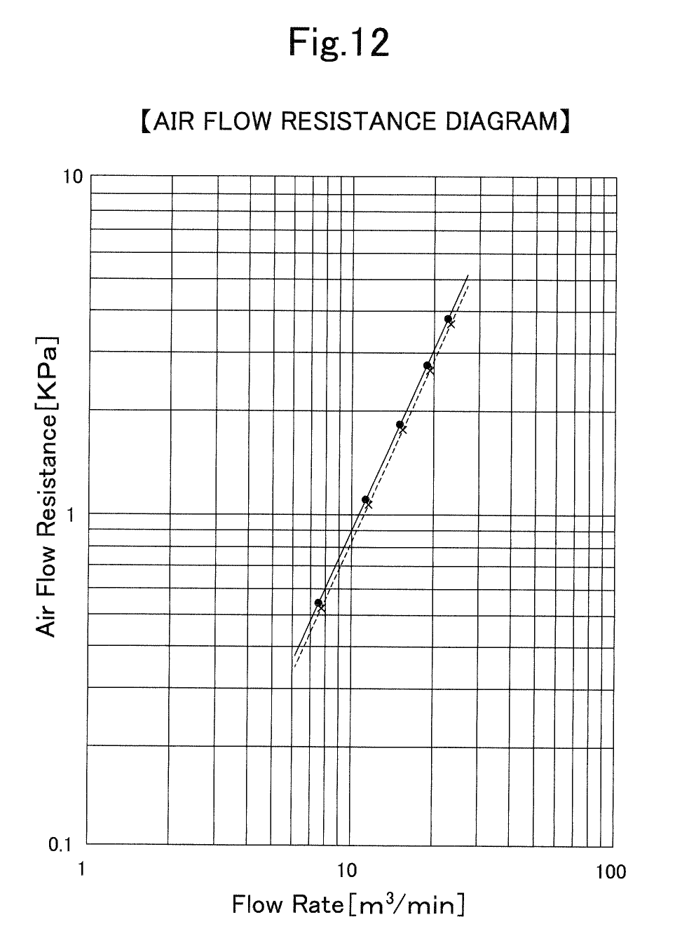

FIG. 12 is a graph showing a relation between air flow resistance and flow rate in the air cleaner 1. In the same figure, the line plotted along black dots represents an experimental result obtained using the air cleaner corresponding to the embodiment of the present invention, while the line plotted along cross marks represents an experimental result obtained using an air cleaner not provided with the pre-filter medium 101. As shown in the graph of FIG. 12 it is seen that in both cases there is no great change in air flow resistance.

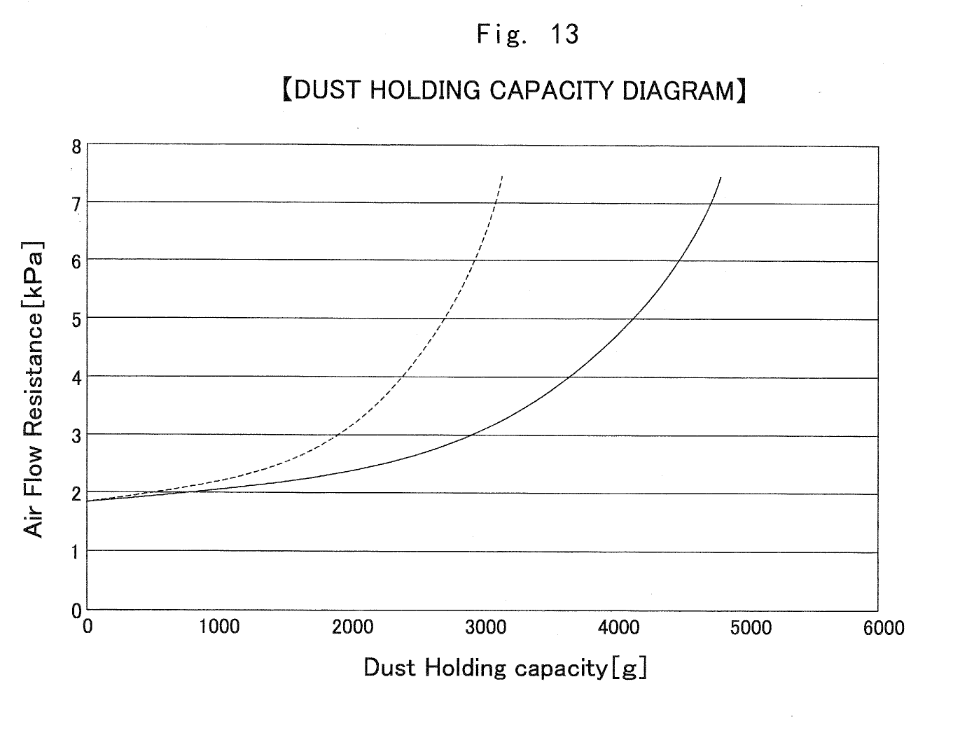

FIG. 13 is a graph showing a relation between dust holding capacity and air flow resistance in the air cleaner 1. In the same figure, a solid line represents an experimental result obtained using the air cleaner corresponding to the embodiment of the present invention, while a dotted line represents an experimental result obtained using an air cleaner nor provided with the pre-filter medium 101. As shown in FIG. 13 it is seen that by accommodating the pre-filter medium 101 in the space IS formed by the main filter medium 21 the dust holding capacity in case of the air flow resistance value being the same is improved to a remarkable extent.

What is claimed is:

1. An air cleaner comprising:
a filter element for filtering gas, comprising:
a cylindrical main filer medium having a space formed on its inner periphery side;
a first closure member provided at one end portion of the main filter medium and having a communication port communicating the space with the exterior;
a second closure member provided at an opposite end portion of the main filter medium to close the space; and
a prefilter medium accommodated within the space, a case for accommodating the filter element, comprising:
a body case, the body case having an opening which permits the filter element to be inserted therein with the second closure member in the read and accommodating the filter element removably in a state in which a gap is formed between the body case and the outer periphery of the main filter medium;
a lid attached to the body case removably to open and close the opening;
a partitioning portion for dividing a gas inflow space with the communication port positioned therein from a gas outflow space with the gap positioned therein while maintaining airtightness and in a state in which the lid is attached to the body case;
a gas inlet port communicating the gas inflow space with the exterior; and
a gas outlet port for communicating the gas outflow space with the exterior.

2. An air cleaner according to claim 1, wherein the filter element permits the pre-filter medium to be accommodated within the space removably from the communication port.

3. An air cleaner according to claim 1, wherein the pre-filter medium has a cylindrical form which opens one side, the open side towards the communication port in a state of the pre-filter medium being accommodated within the space.

4. An air cleaner according to claim 3, wherein the pre-filter medium is closed on its second closure member side in a state of being accommodated within the space.

5. An air cleaner according to claim 2, wherein the number of pre-filter media is plural.

6. An air cleaner according to claim 1, wherein the pre-filter medium is formed by a lump of plural fibrous members.

7. An air cleaner according to claim 1, wherein the pre-filter medium is formed by a spongy member.

8. An air cleaner according to claim 3, wherein the pre-filter medium is formed shorter than an axial length of the main filter medium.

9. An air cleaner according to claim 4, wherein the pre-filter medium is formed shorter than an axial length of the main filter medium.

10. An air cleaner according to claim 5, wherein the pre-filter medium is formed shorter than an axial length of the main filter medium.

11. An air cleaner according to claim 6, wherein the pre-filter medium is formed shorter than an axial length of the main filter medium.

12. An air cleaner according to claim 7, wherein the pre-filter medium is formed shorter than an axial length of the main filter medium.

13. An air cleaner according to claim 1, wherein the gas inlet port is formed in the lid in a state in which an axis thereof is located at a position aligned with an axis of the filter element accommodated within the case.
